(19) United States
(12) Patent Application Publication
(10) Pub. No.: US 2026/0249490 A1
(43) Pub. Date: Aug. 27, 2026

(54) ROBOT AND COVER

(71) Applicant: SUMITOMO HEAVY INDUSTRIES, LTD., Tokyo (JP)

(72) Inventors: Tomohiro KANEISHI, Yokosuka-shi (JP); Yuta MATSUMOTO, Yokosuka-shi (JP); Koji MORITANI, Yokosuka-shi (JP); Masato IWATA, Yokosuka-shi (JP)

(21) Appl. No.: 19/649,164

(22) Filed: Apr. 16, 2026

Related U.S. Application Data
(63) Continuation of application No. PCT/JP2024/035876, filed on Oct. 8, 2024.

(30) Foreign Application Priority Data
Oct. 23, 2023 (JP) 2023-181660

(51) Int. Cl. B25J 19/00

(52) U.S. Cl. CPC B25J 19/0075

(57) ABSTRACT

A robot includes a joint portion, an actuator that drives the joint portion, a wiring member that is disposed outside the actuator, and a cover that covers at least the actuator, in which the cover includes a cover main body portion, and a wiring storage portion that bulges in a direction away from the actuator with respect to the cover main body portion, the wiring member being stored in the wiring storage portion, the wiring storage portion includes an outer protruding portion formed on an outer surface of the cover and an inner groove portion formed on an inner surface of the cover and positioned inside the outer protruding portion, and the outer protruding portion protrudes in a direction away from the actuator with respect to the outer surface of the cover where the wiring storage portion is continuous.

### CROSS-REFERENCE TO RELATED APPLICATIONS

This is a bypass continuation of International PCT Application No. PCT/JP2024/035876, filed on October 8, 2024, which claims priority to Japanese Patent Application No. 2023-181660, filed on October 23, 2023, which are incorporated by reference herein in their entirety.

### BACKGROUND

### TECHNICAL FIELD

A certain embodiment of the present invention relates to a robot and a cover.

### DESCRIPTION OF RELATED ART

The related art discloses an actuator unit including an actuator, a wiring member disposed outside the actuator, and a cover that covers the actuator. The actuator unit is configured as a robot including a joint portion and an actuator that drives the joint portion.

### SUMMARY

One or more embodiment provide a robot includes: a joint portion; an actuator that drives the joint portion; a wiring member that is disposed outside the actuator; and a cover that covers at least the actuator, in which the cover includes a cover main body portion, and a wiring storage portion that bulges in a direction away from the actuator with respect to the cover main body portion, the wiring member being stored in the wiring storage portion.

One or more embodiment provide a cover that is used in an actuator unit including an actuator and a wiring member disposed outside the actuator and that covers the actuator includes: a cover main body portion; and a wiring storage portion that bulges in a direction away from the actuator with respect to the cover main body portion, the wiring member being stored in the wiring storage portion.

### BRIEF DESCRIPTION OF THE DRAWINGS

FIG. 1 is a perspective view of a robot, according to an embodiment.

FIG. 2 is an enlarged view of a range S1 in FIG. 1.

FIG. 3 is a perspective view in which a cover is omitted from FIG. 2.

FIG. 4 is a front cross-sectional view schematically showing an actuator together with a part of a cross section taken along a first output axis L24A in FIG. 2.

FIG. 5 is a left side cross-sectional view schematically showing the actuator together with a part of a cross section taken along a second output axis L24B in FIG. 2.

FIG. 6 is a perspective view of a connection member as viewed from an arrow V1 in FIG. 2.

FIG. 7 is a view of a part of FIG. 3 as viewed from the front.

FIG. 8 is a perspective view of the cover and the connection member as viewed from the same viewpoint as in FIG. 6.

FIG. 9 is a perspective view of the cover as viewed from the same viewpoint as in FIG. 6.

FIG. 10 is a front view of a cover, according to the embodiment.

FIG. 11 is a left side view of the cover, according to the embodiment.

FIG. 12 is a view illustrating a portion of a cross section taken along line XII-XII in FIG. 10.

FIG. 13 is a view illustrating a portion of a cross section taken along line XIII-XIII in FIG. 11.

FIG. 14 is an exploded view of a part of the range S1 in FIG. 1 as viewed from the front.

FIG. 15 is a cross-sectional view of only the cover as viewed from the same viewpoint as in FIG. 13.

FIG. 16 is an XVI-XVI cross-sectional view of FIG. 15.

FIG. 17A is a schematic view showing a cover of a modification as viewed from an arrow V2 in FIG. 12, and FIG. 17B is a cross-sectional view taken along line A-A in FIG. 17A.

FIG. 18 is a perspective view of a cover, according to the embodiment.

FIG. 19 is a top view of the cover, according to the embodiment.

FIG. 20 is a right side view of the cover, according to the embodiment.

FIG. 21 is a bottom view of the cover, according to the embodiment.

FIG. 22 is a rear view of the cover, according to the embodiment.

FIG. 23 is another front view of the cover, according to the embodiment.

FIG. 24 is another left side view of the cover, according to the embodiment.

FIG. 25 is another perspective view of the cover, according to the embodiment.

FIG. 26 is still another perspective view of the cover, according to the embodiment.

### DETAILED DESCRIPTION

Under the structure of the related art, no particular consideration is given to the cover in disposing the wiring member between the actuator and the cover. The present inventors have recognized that there is room for improvement in the disclosed technology of the related art in achieving a reduction in size of the actuator unit.

According to the present disclosure, it is possible to provide a technique for favorably reducing a size of an actuator unit.

Hereinafter, an embodiment for implementing an actuator unit of the present disclosure will be described. The same or equivalent elements will be denoted by the same reference numerals, and the duplicate description thereof will be omitted. In each drawing, the components are omitted, enlarged, or reduced as appropriate for convenience of description. The drawings should be viewed in alignment with the orientation of the reference numerals.

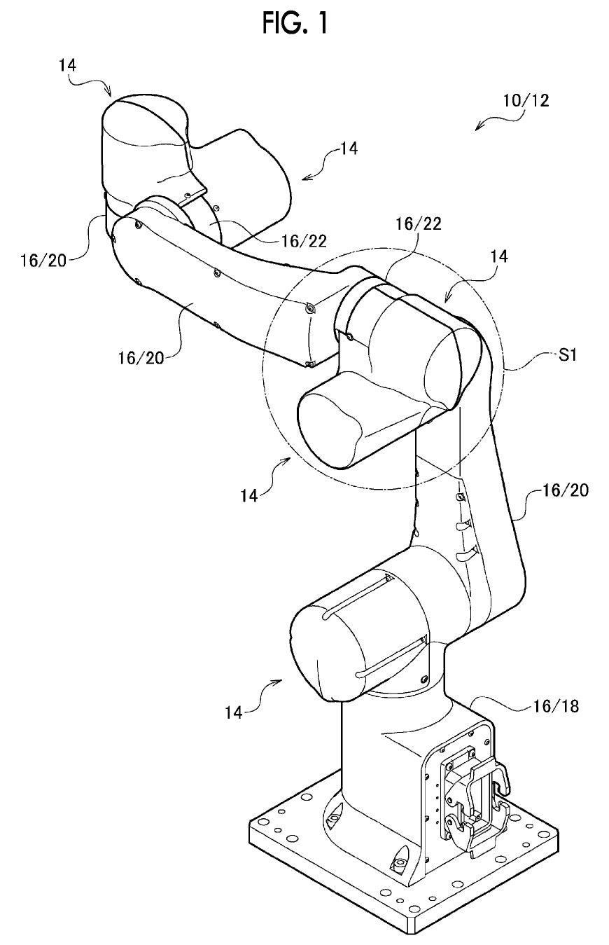

The description will be made with reference to FIG. 1. An actuator unit 10 according to the embodiment is a robot 12. The robot 12 according to the present embodiment is an industrial robot, but may be a service robot or the like. The robot 12 may be a cooperative robot for working in cooperation with a person.

The robot 12 includes joint portions 14 and a plurality of robot members 16 connected in series by the plurality of joint portions 14. The robot 12 according to the present embodiment is an articulated robot having five joints. The number of joints is not particularly limited, and may be any of one to four or six or more. In the robot 12, the robot member 16 on a most base end side is a base member 18 as a pedestal disposed on a floor, and the other robot members 16 are any of an arm member 20 and a connection member 22 (described later). Here, the plurality of joint portions 14 are distinguished from first to fifth stage joint portions from the base end side to a distal end side of the robot 12. In addition, the plurality of robot members 16 are distinguished from first to sixth stage robot members from the base end side to the distal end side of the robot 12.

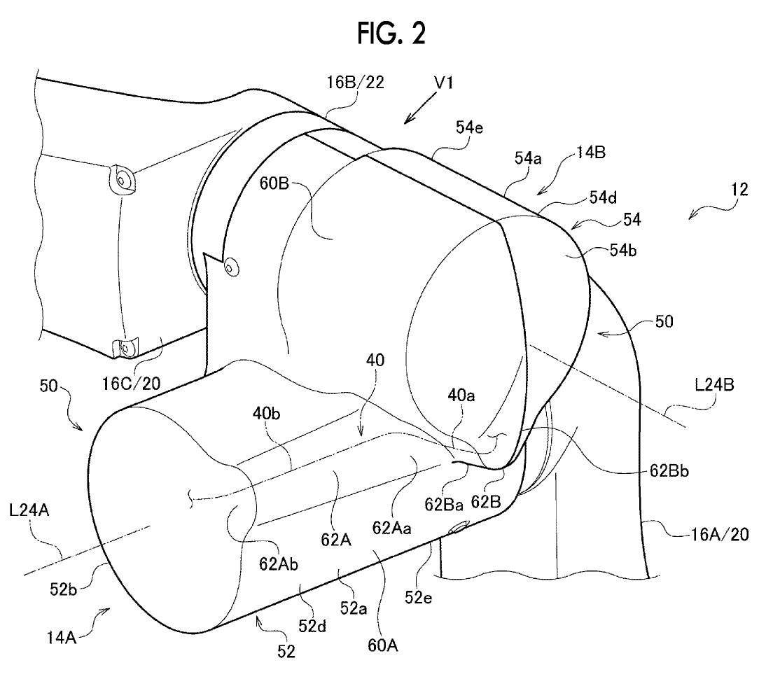

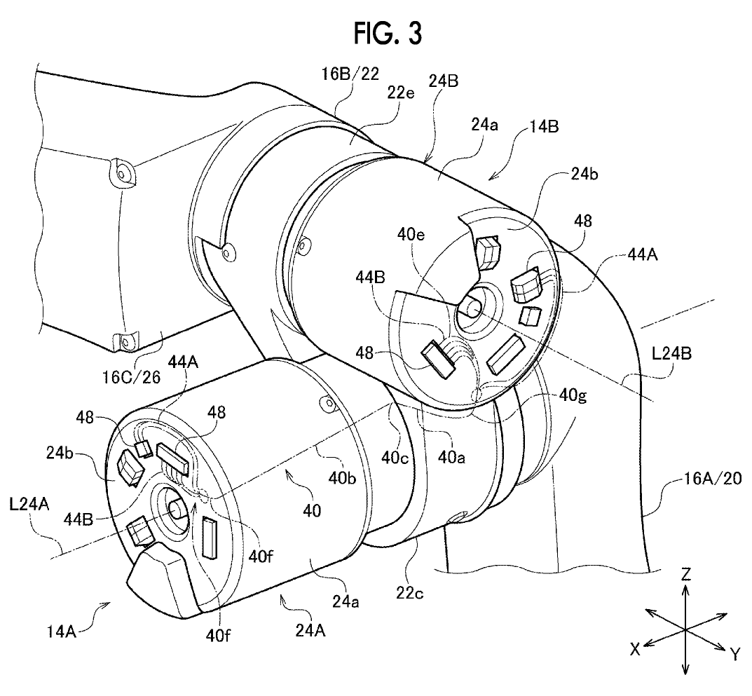

The description will be made with reference to FIGS. 2 and 3. Hereinafter, a configuration around the second and third stage joint portions 14 surrounded by a range S1 in FIG. 1 will be described. This configuration will be described using different reference numerals from those in FIG. 1.

The robot 12 includes a first joint portion 14A that is a second stage joint portion and a second joint portion 14B that is a third stage joint portion. The first joint portion 14A couples a first robot member 16A that is a second stage robot member and a second robot member 16B that is a third stage robot member. The second joint portion 14B couples the second robot member 16B and a third robot member 16C that is a fourth stage robot member. In the present embodiment, the first and third robot members 16A and 16C are configured by the arm member 20, and the second robot member 16B is configured by the connection member 22 described later.

The actuator unit 10 (robot 12) includes actuators 24A and 24B that drive the joint portions 14A and 14B. The term “driving the joint portion” herein means driving the robot member on the distal end side to rotate (perform relative movement) with respect to the robot member on the base end side coupled by the joint portion. The term “rotation” herein is a concept including so-called rotational movement. The actuators 24A and 24B include a first actuator 24A that drives the first joint portion 14A and a second actuator 24B that drives the second joint portion 14B. The actuators 24A and 24B are incorporated into the joint portions 14A and 14B and couple the robot member on the base end side and the robot member on the distal end side. In addition, actuators are incorporated into joint portions other than the second and third stage joint portions in the robot 12.

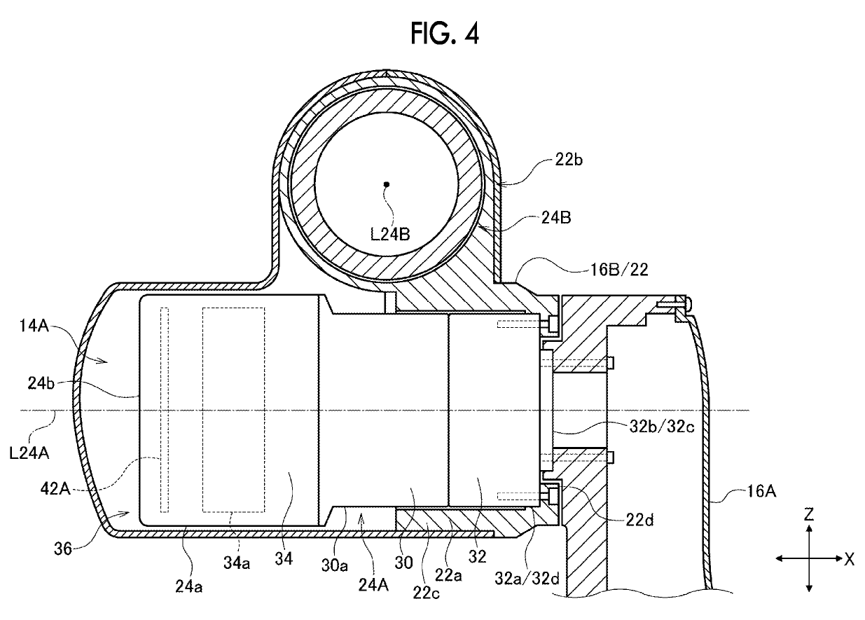

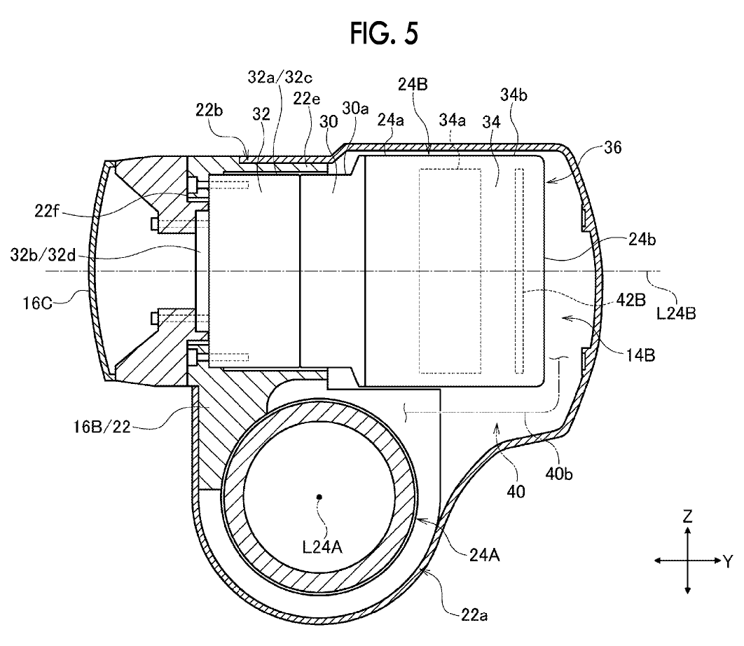

The description will be made with reference to FIGS. 4 and 5. The actuators 24A and 24B include a motor 30, a reducer 32 that decelerates and outputs the rotation input from the motor 30, and a driver unit 34 that is provided on a side opposite to the reducer 32 with respect to the motor 30.

The motor 30 includes a motor casing 30a that accommodates a stator and a rotor (not shown). A specific example of the motor 30 is not particularly limited, and is, for example, a DC motor or an AC motor.

The reducer 32 includes a reducer casing 32a that accommodates a deceleration mechanism (not shown) that decelerates the rotation input from the motor 30, and a reducer internal member 32b of which at least a part is disposed in the reducer casing 32a. A specific example of the deceleration mechanism is not particularly limited. The deceleration mechanism may be, for example, a bending meshing type deceleration mechanism (cylindrical type, silk hat type, cup type, or the like), an eccentric oscillation type deceleration mechanism (center crank type, distributing type, or the like), a simple planetary type deceleration mechanism, an orthogonal-axis gear reduction mechanism, a parallel-axis gear reduction mechanism, or the like. The deceleration mechanism may be a deceleration mechanism using either a gear or a traction drive. The reducer internal member 32b is, for example, a carrier used in the bending meshing type deceleration mechanism or the like.

The reducer 32 includes a fixed portion 32c that is fixed to an external support member for supporting the actuators 24A and 24B, and an output unit 32d for outputting to a driven member driven by the actuators 24A and 24B. One of the fixed portion 32c and the output unit 32d is the reducer casing 32a, and the other is the reducer internal member 32b. The fixed portion 32c of the first actuator 24A is the reducer internal member 32b, and is fixed to the first robot member 16A as the external support member. The output unit 32d of the first actuator 24A is the reducer casing 32a, and is fixed to the second robot member 16B as the driven member. The fixed portion 32c of the second actuator 24B is the reducer casing 32a, and is fixed to the second robot member 16B as the external support member. The output unit 32d of the second actuator 24B is the reducer internal member 32b, and is fixed to the third robot member 16C as the driven member.

The driver unit 34 includes a driver housing 34a on which a driver circuit is mounted, and a driver casing 34b that covers the driver housing 34a.

The actuators 24A and 24B output the output rotation around the output axes L24A and L24B from the output unit 32d of the reducer 32 to the driven member, thereby relatively rotating the driven member with respect to the external support member. The first actuator 24A outputs the output rotation around the first output axis L24A, thereby relatively rotating the second robot member 16B with respect to the first robot member 16A, and thus the first joint portion 14A is driven. The second actuator 24B outputs the output rotation around the second output axis L24B, thereby relatively rotating the third robot member 16C with respect to the second robot member 16B, and thus the second joint portion 14B is driven. Hereinafter, a direction along the first output axis L24A, a circumferential direction with the first output axis L24A as a center of a circle, and a radial direction are referred to as a first axial direction X, a first circumferential direction, and a first radial direction, respectively. In addition, a direction along the second output axis L24B, a circumferential direction with the second output axis L24B as a center of a circle, and a radial direction are referred to as a second axial direction Y, a second circumferential direction, and a second radial direction, respectively.

The actuators 24A and 24B as a whole are long columnar bodies along the output axes L24A and L24B thereof. The actuators 24A and 24B include an outer peripheral portion 24a and a motor-side axial end portion 24b provided on the motor 30 side with respect to the reducer 32. The outer peripheral portion 24a and the motor-side axial end portion 24b of the actuators 24A and 24B are configured by an actuator casing 36 that accommodates other components of the actuators 24A and 24B. The actuator casing 36 of the present embodiment is configured by the motor casing 30a, the reducer casing 32a, and the driver casing 34b described above.

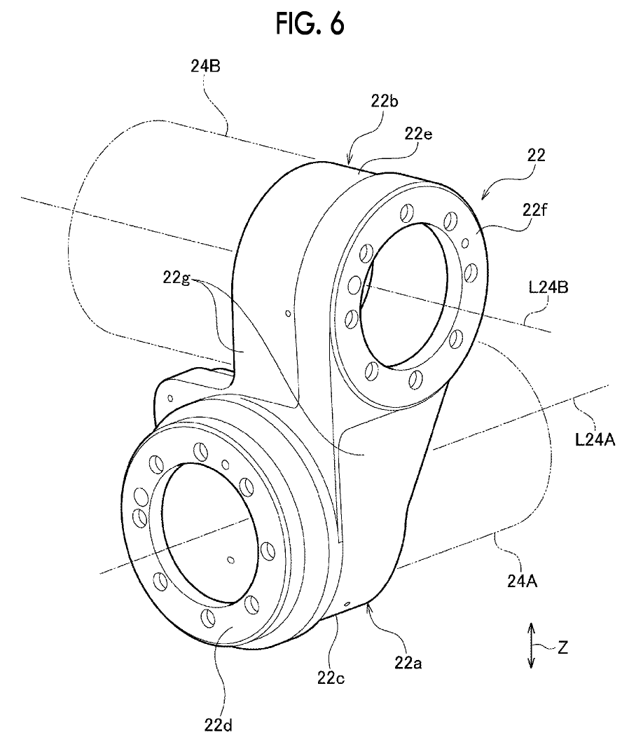

The description will be made with reference to FIGS. 4 to 6. The robot 12 includes a connection member 22 that couples the first actuator 24A and the second actuator 24B. The connection member 22 includes a first actuator fixation portion 22a to which the first actuator 24A is fixed, and a second actuator fixation portion 22b to which the second actuator 24B is fixed. The first and second actuator fixation portions 22a and 22b of the present embodiment are configured such that the first output axis L24A of the first actuator 24A and the second output axis L24B of the second actuator 24B are skewed relative to each other. In the present embodiment, the second output axis L24B extends parallel to an orthogonal surface orthogonal to the first output axis L24A, and the first output axis L24A extends parallel to an orthogonal surface orthogonal to the second output axis L24B. The first and second actuator fixation portions 22a and 22b are configured such that the first actuator 24A and the second actuator 24B overlap each other when viewed in an orthogonal direction Z orthogonal to both the first output axis L24A and the second output axis L24B.

The first actuator fixation portion 22a includes a first tubular portion 22c that surrounds the first actuator 24A, and a first axial direction fixation portion 22d that faces the first actuator 24A in the first axial direction X and to which the first actuator 24A is fixed. The second actuator fixation portion 22b includes a second tubular portion 22e that surrounds the second actuator 24B, and a second axial direction fixation portion 22f that faces the second actuator 24B in the second axial direction Y and to which the second actuator 24B is fixed. The first tubular portion 22c and the second tubular portion 22e are coupled to each other by a coupling portion 22g.

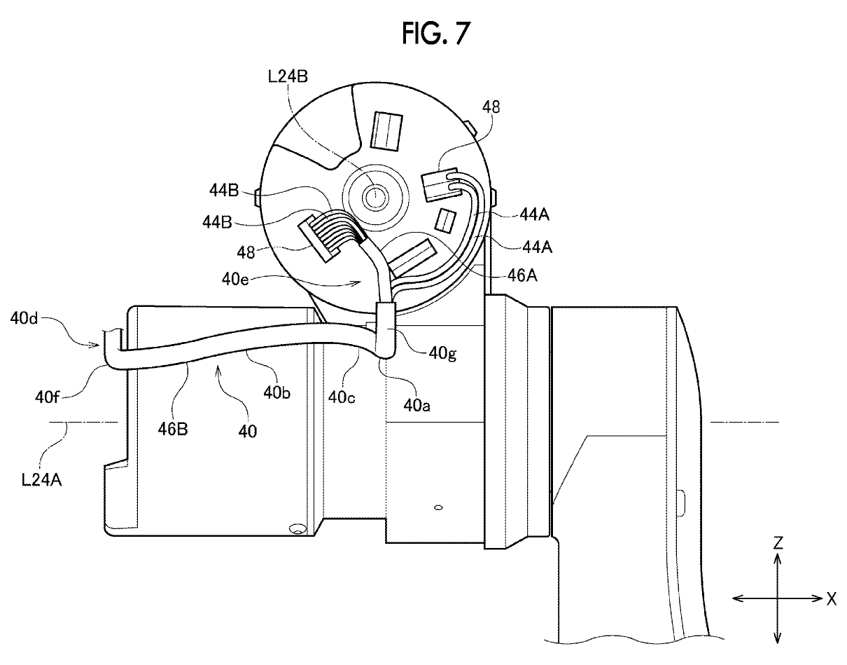

The description will be made with reference to FIGS. 3 and 7. In FIG. 3, only center lines of coating tubes 46A and 46B or wirings 44A and 44B of a wiring member 40, which will be described below, are schematically shown. The actuator unit 10 includes a wiring member 40 disposed outside the actuators 24A and 24B. In order to satisfy the condition of being “disposed outside the actuators 24A and 24B” here, at least a part of the wiring member 40 may be disposed outside the actuators 24A and 24B, and the entire wiring member 40 does not need to be disposed outside the actuators 24A and 24B.

The wiring member 40 of the present embodiment is disposed outside the first and second actuators 24A and 24B. The wiring member 40 electrically connects a first electric device 42A (see FIG. 4) mounted on the first actuator 24A and a second electric device 42B (see FIG. 5) outside the first actuator 24A. The second electric device 42B of the present embodiment is mounted on the second actuator 24B, but may be mounted on the other actuators 24A other than the second actuator 24B, or may be provided outside the robot 12 (actuator unit 10). In the present embodiment, each of the first and second electric devices 42A and 42B is a circuit board disposed in the actuator casing 36. The electric devices 42A and 42B may be any devices that use electricity, and specific examples thereof are not particularly limited. The electric devices 42A and 42B may be, for example, a motor, a sensor, a brake, or the like, in addition to the circuit board.

The wiring member 40 includes at least one of the wirings 44A and 44B. The wiring member 40 of the present embodiment includes a plurality of wirings 44A and 44B and coating tubes 46A and 46B that bundle intermediate portions of the plurality of wirings 44A and 44B. The plurality of wirings 44A and 44B include, for example, a plurality of power supply wirings 44A that constitute a power supply line and a plurality of communication wirings 44B that constitute a communication line. The power supply line is connected to an external power supply via a daisy chain passing through each of the actuators 24A and 24B, and contributes to power supply from the external power supply to the actuators 24A and 24B. The communication line is connected to an upper-level controller via a daisy chain passing through each of the actuators 24A and 24B, and contributes to signal transmission between the actuators 24A and 24B and the upper-level controller. Here, only some of the power supply wirings 44A and the communication wirings 44B constituting the daisy chain are shown. An example in which each of the wirings 44A and 44B is mechanically connected to the electric devices 42A and 42B by a connector 48 is shown, but a connection mode is not particularly limited, and solder, a terminal block, a terminal (a crimp terminal, a pressure contact terminal, or the like), or the like may be used. The connector 48 of the present embodiment penetrates an opening portion provided in the actuator casing 36. In the present embodiment, the plurality of communication wirings 44B are bundled by a first coating tube 46A, and the first coating tube 46A and the plurality of power supply wirings 44A are bundled by a second coating tube 46B. In FIG. 3, circular marks are provided at positions of both end portions of the second coating tube 46B on an outermost side. The purpose and the number of the wirings 44A and 44B are not particularly limited, and the presence or absence of the coating tubes 46A and 46B is not particularly limited.

The wiring member 40 includes a first wiring portion 40a (see also FIG. 5) disposed along an outer shape of the first actuator 24A and a second wiring portion 40b disposed along an outer shape of the second actuator 24B. The first wiring portion 40a and the second wiring portion 40b are connected to each other via a first bent portion 40c. The first wiring portion 40a is disposed to extend in the first axial direction X, and the second wiring portion 40b is disposed to extend in the second axial direction Y. The first wiring portion 40a of the present embodiment is disposed to extend in the first circumferential direction while extending in the first axial direction X, and the second wiring portion 40b is disposed along the second axial direction Y. The second wiring portion 40b is disposed along the outer shape of the second actuator 24B in a direction different from a length direction in which the first wiring portion 40a extends. The first wiring portion 40a is disposed to extend in a first direction along the outer shape of the first actuator 24A, and the second wiring portion 40b is disposed to extend in a second direction different from the first direction along the outer shape of the second actuator 24B.

In addition, the wiring member 40 of the present embodiment includes a third wiring portion 40d disposed on the outer side in the first axial direction X with respect to the motor-side axial end portion 24b of the first actuator 24A in which the first electric device 42A is provided, and a fourth wiring portion 40e disposed on the outer side in the second axial direction Y with respect to the motor-side axial end portion 24b of the second actuator 24B in which the second electric device 42B is provided. The third wiring portion 40d is connected to the first wiring portion 40a via a second bent portion 40f. The fourth wiring portion 40e is connected to the second wiring portion 40b via a third bent portion 40g. In the third wiring portion 40d, a plurality of wirings 44A and 44B are drawn out from one end portion (a location of a circle mark on the right side in FIG. 3) of the second coating tube 46B, and the plurality of drawn-out wirings 44A and 44B are mechanically connected to the first electric device 42A of the first actuator 24A via individual connectors 48. In the fourth wiring portion 40e, a plurality of wirings 44A and 44B are drawn out from the other end portion (a location of a circle mark on the left side in FIG. 3) of the coating tube, and the plurality of drawn-out wirings 44A and 44B are mechanically connected to the second electric device 42B of the second actuator 24B via individual connectors 48.

The description will be made with reference to FIGS. 2, 3, 8, and 9. The actuator unit 10 (robot 12) includes a cover 50 that covers at least the actuators 24A and 24B. The cover 50 of the present embodiment functions as a cover used for the joint portions 14A and 14B of the robot 12, that is, a joint cover for a robot. The cover 50 of the present embodiment covers both the first and second actuators 24A and 24B and the connection member 22.

The cover 50 includes a first cover portion 52 that covers at least the first actuator 24A, and a second cover portion 54 that covers at least the second actuator 24B. The first cover portion 52 includes a first peripheral wall portion 52a that covers the outer peripheral portion 24a of the first actuator 24A from the outer side in the first radial direction, and a first end wall portion 52b that covers the motor-side axial end portion 24b of the first actuator 24A from the outer side in the first axial direction X. A first opening end portion 52c that is open to the outer side in the first axial direction X is provided at an end portion of the first peripheral wall portion 52a on a side opposite to the first end wall portion 52b in the first axial direction X. The second cover portion 54 includes a second peripheral wall portion 54a that covers the outer peripheral portion 24a of the second actuator 24B from the outer side in the second radial direction, and a second end wall portion 54b that covers the motor-side axial end portion 24b of the second actuator 24B from the outer side in the second axial direction Y. A second opening end portion 54c that is open to the outer side in the second axial direction Y is provided at an end portion of the second peripheral wall portion 54a on a side opposite to the second end wall portion 54b in the second axial direction Y.

The description will be made with reference to FIGS. 2, 3, and 10. The first peripheral wall portion 52a includes a first tubular portion 52d that is coupled to the first end wall portion 52b, and a first circumferential portion 52e that is provided on a side opposite to the first end wall portion 52b in the first axial direction X with respect to the first tubular portion 52d. The first tubular portion 52d has a tubular shape surrounding the outer peripheral portion 24a of the first actuator 24A. The first circumferential portion 52e partially covers the outer peripheral portion 24a of the first actuator 24A and partially covers the first tubular portion 22c of the connection member 22, and has a circumferential shape extending in the first circumferential direction. The first circumferential portion 52e covers the first actuator 24A and the connection member 22 at least from a side opposite to the second output axis L24B with respect to the first output axis L24A.

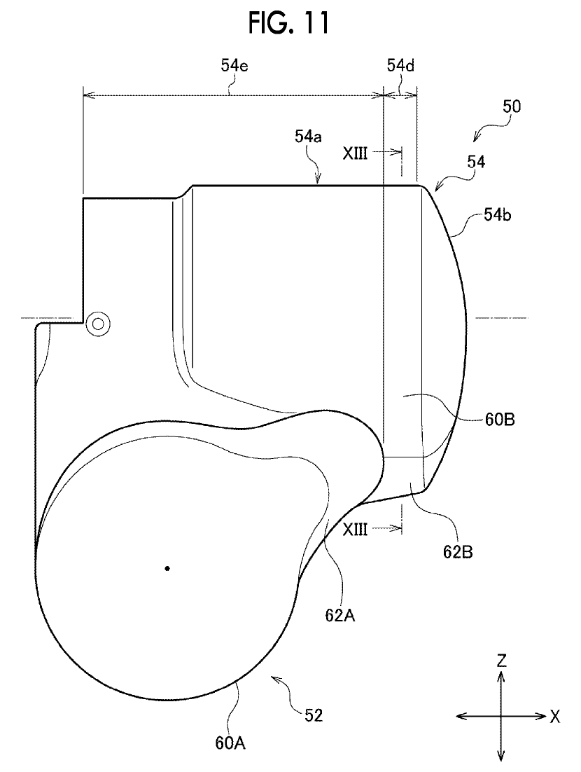

The description will be made with reference to FIGS. 2, 3, and 11. The second peripheral wall portion 54a includes a second tubular portion 54d that is coupled to the second end wall portion 54b, and a second circumferential portion 54e that is provided on a side opposite to the second end wall portion 54b in the second axial direction Y with respect to the second tubular portion 54d. The second tubular portion 54d has a tubular shape surrounding the outer peripheral portion 24a of the second actuator 24B. The second circumferential portion 54e partially covers the outer peripheral portion 24a of the second actuator 24B and partially covers the second tubular portion 22e of the connection member 22, and has a circumferential shape extending in the second circumferential direction. The second circumferential portion 54e covers the second actuator 24B and the connection member 22 at least from a side opposite to the first output axis L24A with respect to the second output axis L24B.

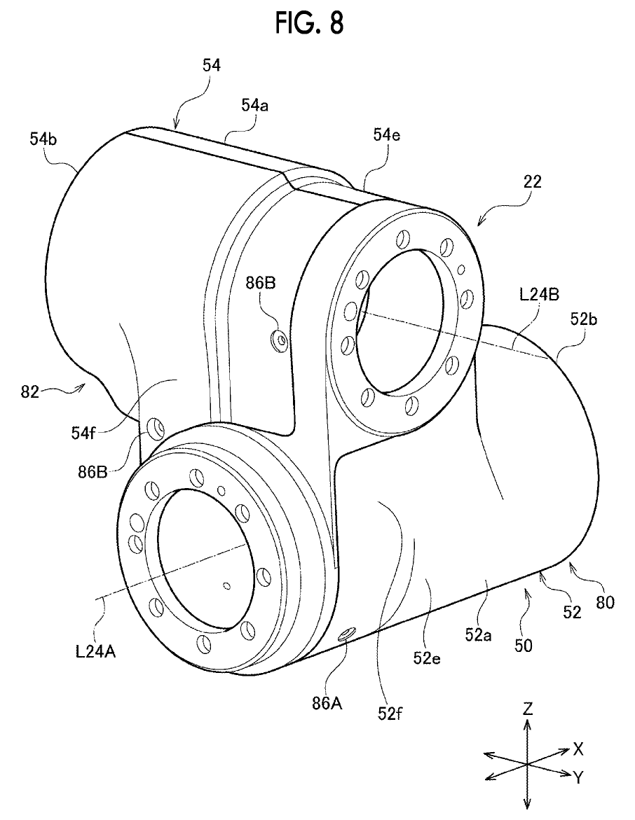

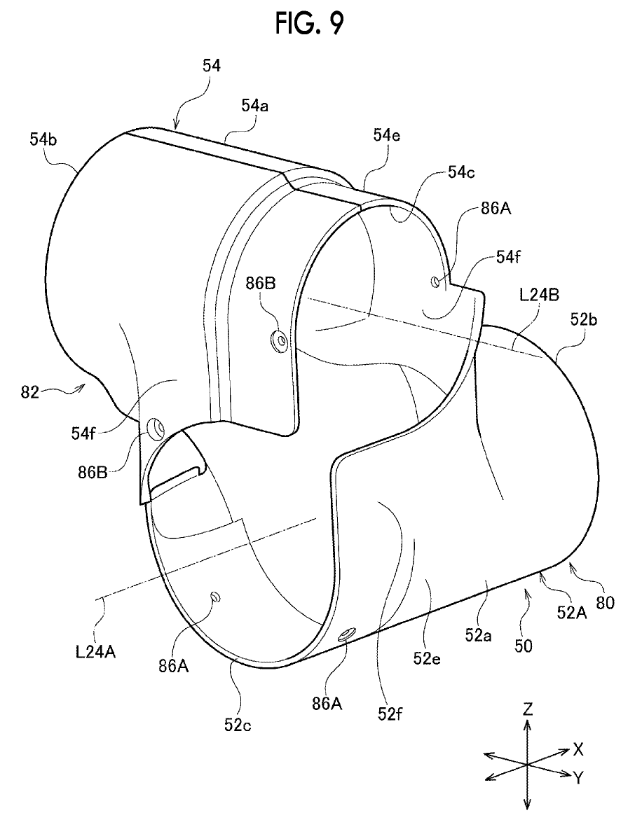

The description will be made with reference to FIGS. 8 and 9. The cover 50 includes extension portions 52f and 54f that extend from the peripheral wall portions 52a and 54a of the cover 50. The extension portions 52f and 54f include a first extension portion 52f that extends from a circumferential end edge portion of the first peripheral wall portion 52a (first circumferential portion 52e) and a second extension portion 54f that extends from a circumferential end edge portion of the second peripheral wall portion 54a (second circumferential portion 54e). The first extension portion 52f covers a part of the connection member 22 from a side opposite to the second end wall portion 54b of the second cover portion 54 in the second axial direction Y with respect to the first output axis L24A. The second extension portions 54f are paired and extend from circumferential end edge portions on both sides in the second circumferential direction of the second peripheral wall portion 54a (second circumferential portion 54e). The paired second extension portions 54f cover a part of the connection member 22 from both sides in the first axial direction X with respect to the second output axis L24B. The second extension portion 54f on the first end wall portion 52b side in the paired second extension portions 54f extends to the first peripheral wall portion 52a, and a part of the second extension portion 54f extends to a side opposite to the second end wall portion 54b in the second axial direction Y and is coupled to the first extension portion 52f.

The description will be made with reference to FIGS. 2, 3, 10, and 11. The cover 50 includes cover main body portions 60A and 60B and wiring storage portions 62A and 62B that constitute the cover portions 52 and 54. The cover 50 of the present embodiment includes a first cover main body portion 60A and a first wiring storage portion 62A that constitute the first cover portion 52, and a second cover main body portion 60B and a second wiring storage portion 62B that constitute the second cover portion 54. The first cover main body portion 60A constitutes a portion other than the first wiring storage portion 62A in the first cover portion 52. The second cover main body portion 60B constitutes a portion other than the second wiring storage portion 62B in the second cover portion 54. The first cover portion 52, the first cover main body portion 60A, the first wiring storage portion 62A, and the first actuator 24A correspond to each other, and the second cover portion 54, the second cover main body portion 60B, the second wiring storage portion 62B, and the second actuator 24B correspond to each other.

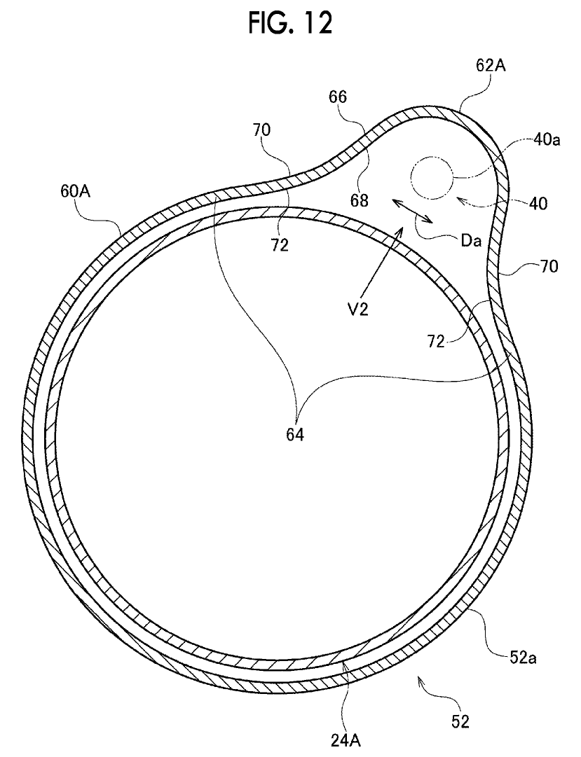

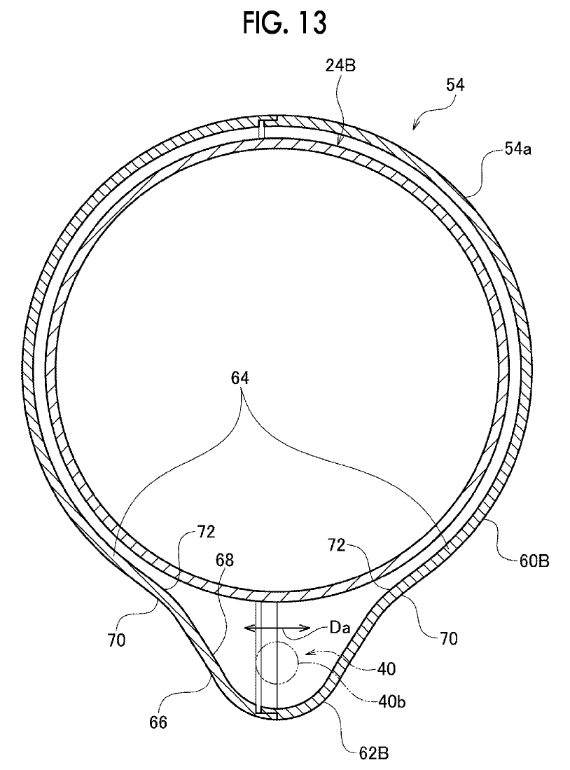

The description will be made with reference to FIGS. 2, 12, and 13. The wiring storage portions 62A and 62B bulge in a direction away from the actuators 24A and 24B corresponding to the wiring storage portions 62A and 62B with respect to the cover main body portions 60A and 60B corresponding to the wiring storage portions 62A and 62B, and a part of the wiring member 40 is stored in the wiring storage portions 62A and 62B. The first wiring storage portion 62A bulges in a direction away from the first actuator 24A with respect to the first cover main body portion 60A, and the second wiring storage portion 62B bulges in a direction away from the second actuator 24B with respect to the second cover main body portion 60B. The wiring storage portions 62A and 62B are provided on at least one of the peripheral wall portions 52a and 54a and the end wall portions 52b and 54b of the cover portions 52 and 54 corresponding to the wiring storage portions 62A and 62B. That is, the first wiring storage portion 62A is provided on at least one of the first peripheral wall portion 52a and the first end wall portion 52b, and the second wiring storage portion 62B is provided on at least one of the second peripheral wall portion 54a and the second end wall portion 54b. In the present embodiment, the first wiring storage portion 62A is provided on the first peripheral wall portion 52a, and the second wiring storage portion 62B is provided on the second peripheral wall portion 54a. In a case where the wiring storage portions 62A and 62B are provided on the peripheral wall portions 52a and 54a as described above, a direction away from the actuators 24A and 24B corresponding to the wiring storage portions 62A and 62B refers to a radially outer side of the actuators 24A and 24B. In a case where the wiring storage portions 62A and 62B are provided on the end wall portions 52b and 54b of the cover 50, a direction away from the actuators 24A and 24B corresponding to the wiring storage portions 62A and 62B refers to an axial outer side of the actuators 24A and 24B.

The first wiring portion 40a of the wiring member 40 is stored in the first wiring storage portion 62A, and the second wiring portion 40b of the wiring member 40 is stored in the second wiring storage portion 62B. One end portion 62Aa of the first wiring storage portion 62A and one end portion 62Ba of the second wiring storage portion 62B are connected to each other, and internal spaces for storing the wiring member 40 in the first wiring storage portion 62A and the second wiring storage portion 62B communicate with each other. In the present embodiment, the other end portion 62Ab of the first wiring storage portion 62A extends to the first end wall portion 52b of the cover 50, and the other end portion 62Bb of the second wiring storage portion 62B extends to the second end wall portion 54b of the cover 50. The wiring storage portions 62A and 62B extend linearly as a whole, but may extend in an elongated shape such as a curved shape.

A direction that is away from the actuators 24A and 24B and that is orthogonal (intersecting) to the length direction of the wiring storage portions 62A and 62B is referred to as a width direction Da of the wiring storage portions 62A and 62B. The length direction of the wiring storage portions 62A and 62B here refers to a direction in which an outer protruding portion 66 (inner groove portion 68) described below, which is configured by the wiring storage portions 62A and 62B, extends. The cover main body portions 60A and 60B include widthwise continuous portions 64 that are continuous in the width direction Da with respect to the wiring storage portions 62A and 62B. The widthwise continuous portion 64 is provided along the outer shape of the actuators 24A and 24B covered by the widthwise continuous portion 64. The expression “provided along the outer shape” here does not mean that the widthwise continuous portion 64 is provided to match the outer shape of the actuators 24A and 24B at a portion covered by the widthwise continuous portion 64, but means that the widthwise continuous portion 64 is provided to have a shape similar to the outer shape of the actuators 24A and 24B as a whole at the portion covered by the widthwise continuous portion 64. The widthwise continuous portion 64 of the present embodiment has a circumferential shape (arc shape) along the peripheral wall portions 52a and 54a of the actuators 24A and 24B. The wiring storage portions 62A and 62B bulge in a direction away from the actuators 24A and 24B with respect to the widthwise continuous portions 64 of the cover main body portions 60A and 60B.

The wiring storage portions 62A and 62B include an outer protruding portion 66 formed on an outer surface of the cover 50 and an inner groove portion 68 formed on an inner surface of the cover 50 and positioned inside the outer protruding portion 66. The outer protruding portion 66 protrudes in a direction away from the actuators 24A and 24B from the outer surfaces of the cover main body portions 60A and 60B (widthwise continuous portions 64) in which the wiring storage portions 62A and 62B are continuous. An outer surface of the outer protruding portion 66 is continuous with an outer surface of the cover main body portions 60A and 60B via a recessed surface portion 70 that is recessed toward the inside of the cover 50. The recessed surface portion 70 may be formed by intersecting a plane and any one of a flat surface or a concave curved surface, may be formed by a single concave curved surface, or may be formed by a plurality of concave curved surfaces having different curvature radii. The recessed surface portion 70 of the present embodiment is formed by a single or a plurality of concave curved surfaces, and has good designability by making the inflection points inconspicuous. The inner groove portion 68 is recessed in a direction away from the actuators 24A and 24B from the inner surfaces of the cover main body portions 60A and 60B (widthwise continuous portions 64) in which the wiring storage portions 62A and 62B are continuous. An inner surface of the inner groove portion 68 is continuous with an inner surface of the cover main body portions 60A and 60B via a protruding surface portion 72 that protrudes toward the inside of the cover 50. The protruding surface portion 72 may be formed by intersecting a plane and any one of a flat surface or a convex curved surface, may be formed by a single convex curved surface, or may be formed by a plurality of convex curved surfaces having different curvature radii.

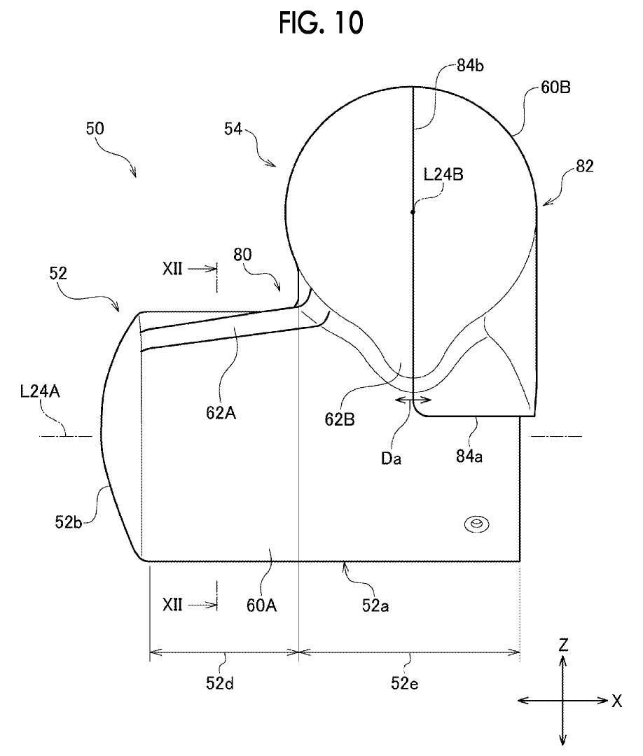

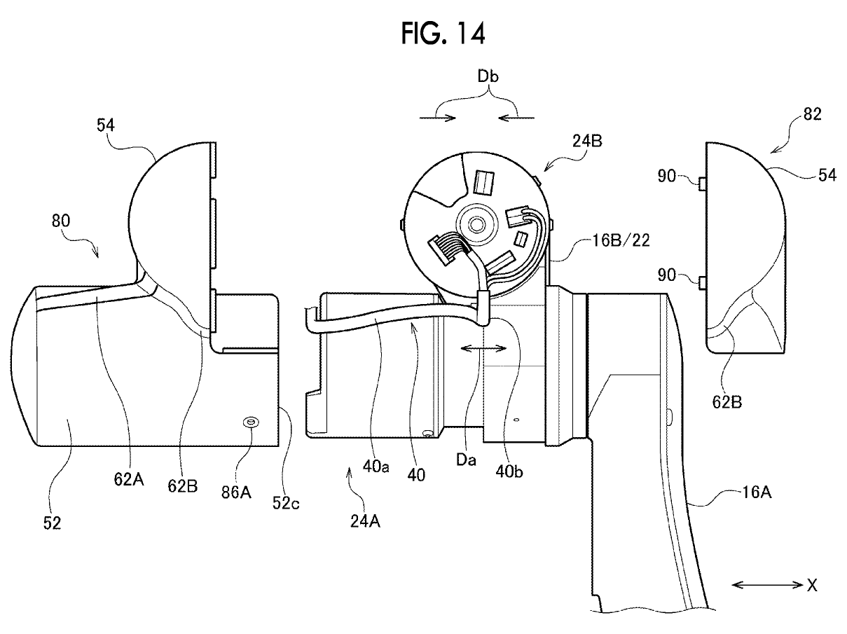

The description will be made with reference to FIGS. 10 and 14. The cover 50 is divided into at least a first divided body 80 and a second divided body 82. It can be said that the cover 50 is divided into a plurality of divided bodies 80 and 82. Accordingly, the cover 50 can be obtained by combining the plurality of divided bodies 80 and 82. The number of the plurality of divided bodies 80 and 82 may be three or more. The divided bodies 80 and 82 are, for example, resin molded products molded by three-dimensional modeling or the like, but may be cast products using metal or the like, and the materials and molding methods thereof are not particularly limited.

The plurality of divided bodies 80 and 82 of the present embodiment are provided to divide the cover 50 in the first axial direction X. The first divided body 80 is provided on the first end wall portion 52b side of the cover 50 with respect to boundary portions 84a and 84b between the first and second divided bodies 80 and 82, and the second divided body 82 is provided on a side opposite to the first end wall portion 52b in the first axial direction X with respect to the boundary portions 84a and 84b. The boundary portions 84a and 84b between the first divided body 80 and the second divided body 82 include a first boundary portion 84a that divides the first cover portion 52 and a second boundary portion 84b that divides the second cover portion 54 in the first axial direction X.

The second boundary portion 84b is provided to divide the second wiring storage portion 62B in the first axial direction X. The second wiring storage portion 62B is formed by at least the first divided body 80 and the second divided body 82, and the second boundary portion 84b is provided to divide the second wiring storage portion 62B in the width direction Da of the second wiring storage portion 62B. Accordingly, the second wiring storage portion 62B can be obtained by combining the plurality of divided bodies 80 and 82. In the present embodiment, the first wiring storage portion 62A is formed only by the first divided body 80.

The description will be made with reference to FIGS. 8 and 9. The cover 50 includes cover fixation portions 86A and 86B for fixing the cover 50 to a partner member that is any one of the actuators 24A and 24B or the connection member 22. In the present embodiment, each of the divided bodies 80 and 82 includes individual cover fixation portions 86A and 86B. In the present embodiment, the first divided body 80 includes a first cover fixation portion 86A for fixing the first divided body 80 to the connection member 22 as a partner member, and the second divided body 82 includes a second cover fixation portion 86B for fixing the second divided body 82 to the connection member 22 as a partner member. In the present embodiment, the first cover fixation portion 86A is provided at a location that serves as the second peripheral wall portion 54a of the cover 50 in addition to a location that serves as the first peripheral wall portion 52a of the cover 50. The first cover fixation portion 86A is fixed to the partner member by using a first fastener such as a bolt. In the present embodiment, the second cover fixation portion 86B is provided at a location that serves as the second extension portion 54f in addition to a location that serves as a boundary portion between the second peripheral wall portion 54a and the second extension portion 54f of the cover 50. The second cover fixation portion 86B is fixed to the partner member by using a second fastener such as a bolt. Here, a case where the cover fixation portions 86A and 86B are fixed to the connection member 22 has been described, but in a case where the cover fixation portions 86A and 86B are fixed to the actuators 24A and 24B, for example, the cover fixation portions 86A and 86B may be fixed to the actuator casing 36.

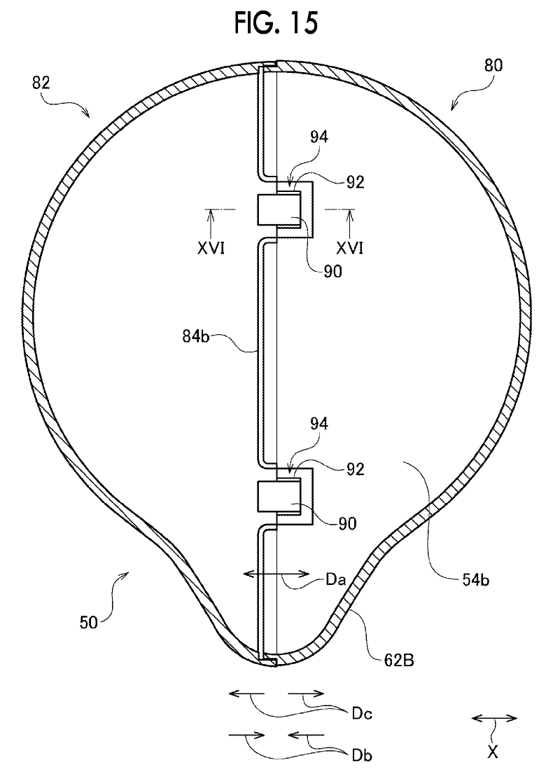

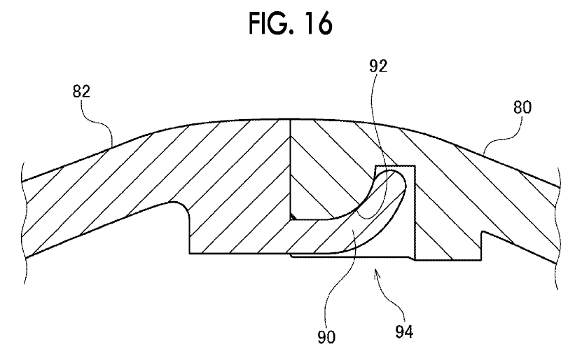

The description will be made with reference to FIGS. 15 and 16. An engagement portion 90 is provided in one of the first and second divided bodies 80 and 82 (here, the second divided body 82). An engagement target portion 92 with which the engagement portion 90 is engaged is provided in the other of the first and second divided bodies 80 and 82 (here, the first divided body 80). The divided bodies 80 and 82 adjacent to each other are connected to each other by engaging the engagement portion 90 with the engagement target portion 92. For example, the engagement portion 90 is an elastic claw that is elastically bendable and deformable, and the engagement target portion 92 is a claw receiving portion that receives the elastic claw.

An engagement unit 94 consisting of a set of the engagement portion 90 and the engagement target portion 92 is provided at the boundary portion 84b between the divided bodies 80 and 82 adjacent to each other. In the present embodiment, a plurality of engagement units 94 are provided at the second boundary portion 84b between the divided bodies 80 and 82 adjacent to each other. In the present embodiment, the engagement unit 94 is provided at the second end wall portion 54b of the cover 50. The engagement unit 94 is provided inside each of the divided bodies 80 and 82 to be invisible from the outside.

The divided bodies 80 and 82 adjacent to each other are moved relative to each other in a connection direction Db in which the divided bodies 80 and 82 approach each other, so that the engagement portion 90 is engaged with the engagement target portion 92, and the divided bodies 80 and 82 are connected to each other. In this process, the elastic claw constituting the engagement portion 90 is engaged with the claw receiving portion with elastic bending and deformation of the elastic claw. In addition, the divided bodies 80 and 82 adjacent to each other are moved relative to each other in a connection release direction Dc in which the divided bodies 80 and 82 are separated from each other, so that the engagement portion 90 is disengaged from the engagement target portion 92, and the connection therebetween is released. In this process, the engagement of the elastic claw with the claw receiving portion is released with elastic bending and deformation of the elastic claw constituting the engagement portion 90. The connection direction Db and the connection release direction Dc are parallel to a direction in which the divided bodies 80 and 82 adjacent to each other face each other at the boundary portion 84b, and are directions along the first axial direction X (width direction Da of the second wiring storage portion 62B) in the present embodiment.

A procedure for assembling the actuator unit 10 (robot 12) using the cover 50 will be described. The description will be made with reference to FIG. 14. First, the configuration components of the actuator unit 10 (robot 12) excluding the cover 50 are assembled in advance. Here, the fixed portion 32c (not shown) of the first actuator 24A is fixed to the first robot member 16A, and the connection member 22 (second robot member 16B) is fixed to the output unit 32d (not shown) of the first actuator 24A. In addition, although not shown, the fixed portion 32c of the second actuator 24B is fixed to the connection member 22, and the third robot member 16C is fixed to the output unit 32d of the second actuator 24B. In addition, here, other configuration members of the robot 12 are also assembled.

In this state, the first divided body 80 is moved to the first opening end portion 52c side (right side of the paper surface in the drawing) in the first axial direction X, so that the first actuator 24A is inserted into the inside of the first divided body 80 at a location of the first opening end portion 52c. In this case, the connection member 22 is also inserted into the inside of the first divided body 80 at a location of the first opening end portion 52c. As a result, the first wiring portion 40a of the wiring member 40 is disposed in the first wiring storage portion 62A of the first divided body 80. Thereafter, the first cover fixation portion 86A of the first divided body 80 is fixed to the partner member (here, the connection member 22) by using the first fastener.

Next, the second divided body 82 is moved to the side (left side of the paper surface in the drawing) close to the first divided body 80 in the first axial direction X. Accordingly, the first divided body 80 and the second divided body 82 are relatively moved in the connection direction Db described above, and the first divided body 80 and the second divided body 82 are connected to each other by the engagement unit 94 described above. Accordingly, the first and second actuators 24A and 24B are disposed inside the first and second divided bodies 80 and 82. In addition, the second wiring portion 40b of the wiring member 40 is disposed in the second wiring storage portion 62B of each of the divided bodies 80 and 82. Thereafter, the second cover fixation portion 86B (not shown) of the second divided body 82 is fixed to the partner member (here, the connection member 22) by using the second fastener. In these processes, the divided bodies 80 and 82 are moved in a direction in which the divided bodies 80 and 82 are close to each other in the width direction Da of the second wiring storage portion 62B.

It is assumed that the first actuator 24A, the first wiring portion 40a of the wiring member 40, and the first cover portion 52 of the cover 50 are not present, and that only the second actuator 24B, the second wiring portion 40b of the wiring member 40, and the second cover portion 54 of the cover 50 are present. In this case, in a case where the second cover portion 54 of the cover 50 is moved along the length direction (here, the direction orthogonal to the paper surface) of the second wiring storage portion 62B so that the second cover portion 54 of the cover 50 covers the outside of the second actuator 24B and the second wiring portion 40b of the wiring member 40, the second wiring storage portion 62B of the second cover portion 54 is likely to interfere with the second wiring portion 40b of the wiring member 40.

(A) In this regard, the two divided bodies 80 and 82 of the present embodiment are provided to divide the second wiring storage portion 62B in the width direction Da. Therefore, the divided bodies 80 and 82 are moved in a direction in which the divided bodies 80 and 82 are close to each other from both sides of the second wiring storage portion 62B in the width direction Da with respect to the second wiring portion 40b of the wiring member 40, so that the second cover portion 54 of the cover 50 can be covered on the outside of the second actuator 24B and the second wiring portion 40b of the wiring member 40. Therefore, in covering the outside of the second actuator 24B and the second wiring portion 40b of the wiring member 40 with the second cover portion 54 of the cover 50, the second wiring portion 40b of the wiring member 40 and the cover 50 are less likely to interfere with each other, and good assemblability can be obtained.

The first wiring storage portion 62A of the first cover portion 52 is provided to extend in the first axial direction X, and the boundary portions 84a and 84b (see FIG. 10) of the two divided bodies 80 and 82 are provided to divide the second wiring storage portion 62B of the second cover portion 54 in the first axial direction X. In this structure, as described above, when the first divided body 80 is moved to the first opening end portion 52c side (right side of the paper surface in the drawing) in the first axial direction X, the first wiring portion 40a of the wiring member 40 can be inserted along the first wiring storage portion 62A of the first divided body 80. In addition, in this case, the second wiring portion 40b of the wiring member 40 can be inserted into the inside of a portion where the second wiring storage portion 62B of the first divided body 80 is formed. In addition, as described above, when the second divided body 82 is moved to the side (left side of the paper surface in the drawing) close to the first divided body 80 in the first axial direction X, the second wiring portion 40b of the wiring member 40 can be inserted into the inside of a portion where the second wiring storage portion 62B of the second divided body 82 is formed. Accordingly, even in a case where the wiring member 40 includes the first wiring portion 40a and the second wiring portion 40b, the cover 50 can be assembled without causing significant interference with the first wiring portion 40a and the second wiring portion 40b.

The effects of the actuator unit 10 (robot 12) will be described.

The cover 50 includes the wiring storage portions 62A and 62B that bulge in a direction away from the actuators 24A and 24B with respect to the cover main body portions 60A and 60B and that store the wiring member 40 inside. Therefore, the cover main body portions 60A and 60B can secure a storage space for the wiring member 40 in the wiring storage portions 62A and 62B that bulge more than the cover main body portions 60A and 60B while being as close to the outer shapes of the actuators 24A and 24B as possible. Therefore, in a cross section of the wiring storage portions 62A and 62B orthogonal to the length direction, the inner surface of a part of the cover main body portions 60A and 60B (widthwise continuous portion 64 of the cover main body portions 60A and 60B) is separated from the outer shapes of the actuators 24A and 24B by the same amount as the minimum distance from the outer shapes of the actuators 24A and 24B to bottom portions of the wiring storage portions 62A and 62B, so that the enlargement of the part of the cover main body portions 60A and 60B can be avoided as compared with a case where the inner surface of the part of the cover main body portions 60A and 60B is separated from the outer shapes of the actuators 24A and 24B. As a result, there is an advantage in achieving a smaller size of the actuator unit 10.

By storing a part of the wiring member 40 in the wiring storage portions 62A and 62B of the cover 50, the movement of the wiring member 40 in the width direction in the wiring storage portions 62A and 62B can be restricted. As a result, the risk of the end portion of the wiring member 40 being detached from the electric devices 42A and 42B due to the movement of the wiring member 40 can be reduced.

The divided bodies 80 and 82 adjacent to each other are connected to each other by engaging one engagement portion 90 of the first and second divided bodies 80 and 82 with the other engagement target portion 92. Therefore, parts of the divided bodies 80 and 82 adjacent to each other can be connected to each other without using a dedicated member (screw or the like) for connecting the divided bodies 80 and 82 adjacent to each other. In particular, in a case where the divided bodies 80 and 82 having a three-dimensional shape are configured by a resin molding product molded by three-dimensional modeling, the distance between the divided bodies 80 and 82 adjacent to each other at the boundary portion is likely to vary due to the influence of a molding error. Depending on the magnitude of the variation, a large gap may partially occur between the divided bodies 80 and 82 adjacent to each other. In this regard, the divided bodies 80 and 82 adjacent to each other according to the present embodiment are relatively moved in the connection direction Db in which the divided bodies 80 and 82 are brought close to each other, so that the engagement portion 90 is engaged with the engagement target portion 92. Therefore, even in a case where such a large partial gap occurs, the engagement portion 90 can be engaged with the engagement target portion 92 after the divided bodies 80 and 82 adjacent to each other in the connection direction Db in which the gap is narrowed are relatively moved. Therefore, the divided bodies 80 and 82 adjacent to each other can be connected to each other in a state where the gap is reduced or eliminated.

The cover 50 covers both the first and second actuators 24A and 24B. Therefore, the first and second actuators 24A and 24B that drive the individual joint portions 14A and 14B can be covered with the common cover 50. The number of components related to the cover 50 can be reduced as compared to a case where the individual covers 50 are used for the first and second actuators 24A and 24B.

The cover 50 includes a first wiring storage portion 62A that stores the first wiring portion 40a of the wiring member 40 and a second wiring storage portion 62B that stores the second wiring portion 40b. Therefore, each of the first and second wiring portions 40a and 40b disposed along the individual actuators 24A and 24B can be stored in the first and second wiring storage portions 62A and 62B of the common cover 50.

The cover 50 covers the connection member 22 in addition to the first and second actuators 24A and 24B. Therefore, the boundary portion between the first actuator 24A and the connection member 22 and the boundary portion between the second actuator 24B and the connection member 22 are covered with the cover 50, so that a clean appearance can be obtained.

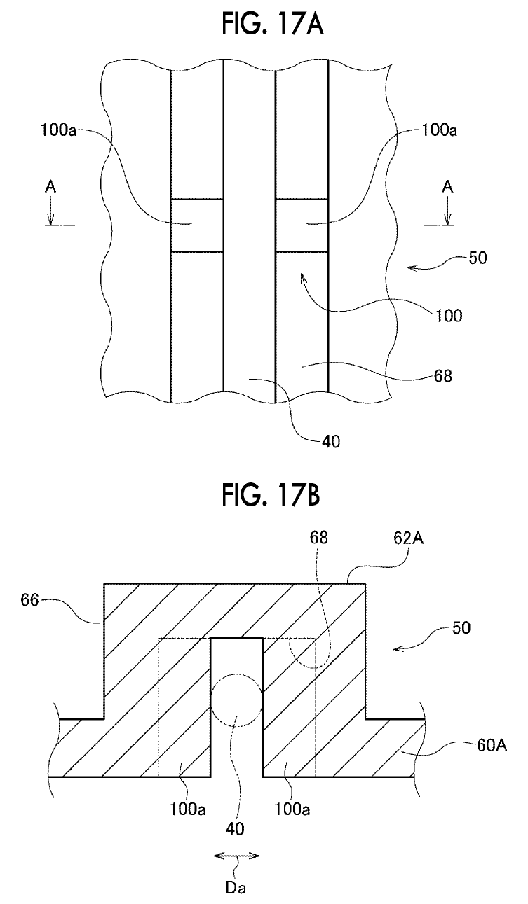

Next, a modification of the cover 50 will be described. The description will be made with reference to FIGS. 17A and 17B. The cover 50 may include a restraining portion 100 that restrains the movement of the intermediate portion of the wiring member 40. The restraining portion 100 is provided in the inner groove portion 68 of the wiring storage portion 62A. The restraining portion 100 is composed of a pair of rib portions 100a provided on a pair of inner side surfaces of the inner groove portion 68. The pair of rib portions 100a are provided to protrude from the inner side surfaces in a direction in which the groove width of the inner groove portion 68 is narrowed. By disposing a part of the wiring member 40 in the restraining portion 100, the movement of the part in the width direction Da of the wiring storage portion 62A is restrained as compared with a case where the restraining portion 100 is not provided. Accordingly, a risk that the end portions of the wiring member 40 are detached from the electric devices 42A and 42B due to the movement of the intermediate portion of the wiring member 40 can be reduced.

Here, an example in which the movement of the wiring member 40 in the width direction Da is restrained has been described, but the movement of the wiring member 40 in a direction approaching the actuator 24A (downward direction in the plane of FIG. 17B) may be restrained. For example, this may be realized by providing a portion in which the groove width is narrowed in the middle of the inner groove portion 68 from a back side toward an inlet side. In addition, an example in which the restraining portion 100 is provided in the wiring storage portion 62 has been described, but the restraining portion 100 may be provided inside the cover main body portions 60A and 60B at a location other than the wiring storage portion 62. In addition, the number of restraining portions 100 of the cover 50 is not particularly limited, and a plurality of restraining portions 100 may be provided.

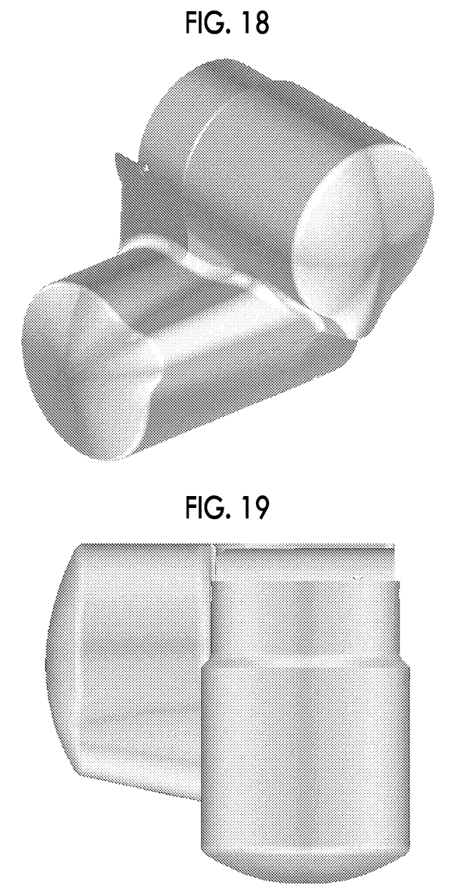

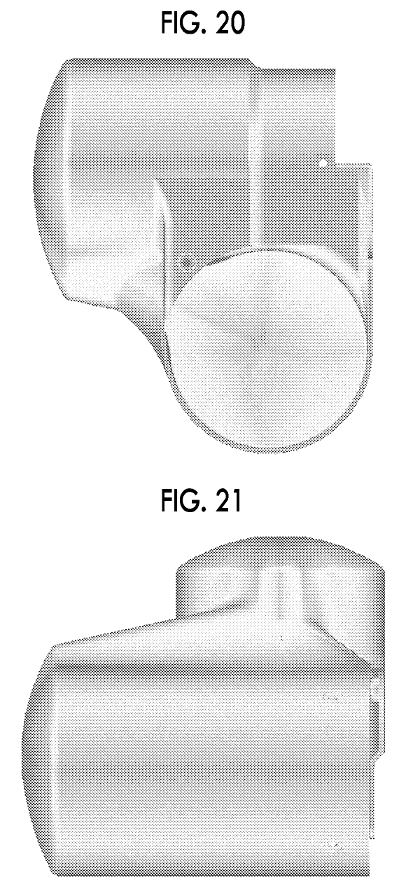

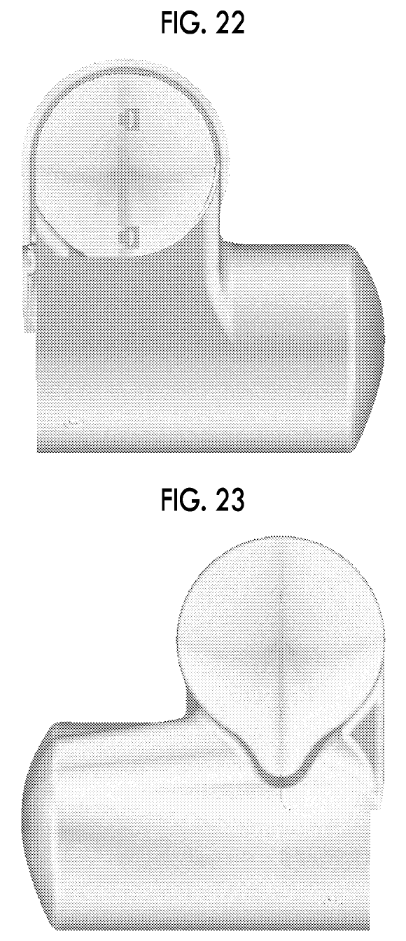

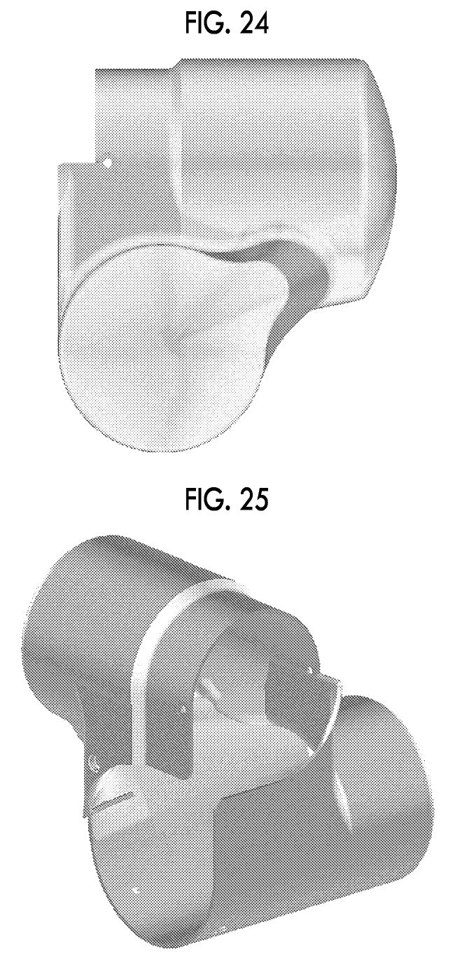

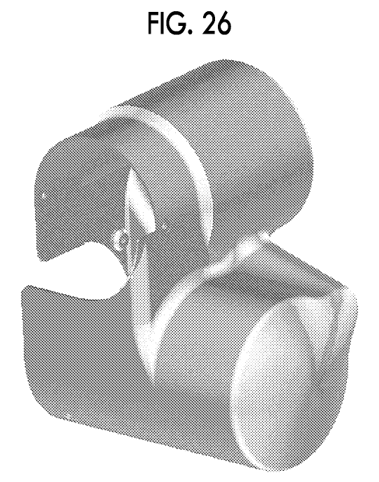

FIGS. 18 to 26 are views showing the cover 50 according to the embodiment. The shading in the present drawings is for specifying the shape and does not specify the pattern or the color.

A modification of the above-described embodiment will be described.

So far, the robot 12 has been described as an example of the actuator unit 10 to which the cover 50 is applied, but the specific example thereof is not particularly limited. The actuator unit 10 may be used, for example, as a part of various industrial machines (machine tools, construction machines, and the like), transport apparatuses (conveyors, vehicles, and the like), and the like, in addition to the robot 12.

The actuator unit 10 may include only the first actuator 24A and may not include the connection member 22 and the second actuator 24B. For example, this case assumes that the actuator unit 10 is not the robot 12. In this case, the cover 50 may cover only the first actuator 24A.

In a case where the actuator unit 10 is the robot 12, the cover 50 may cover only the first actuator 24A and may not cover one or both of the connection member 22 and the second actuator 24B.

The number of stages of the actuators covered by the cover 50 is not particularly limited. For example, the first and second stage actuators 24 may be covered by a common cover 50, or the fourth and fifth stage actuators may be covered by a common cover 50.

In covering both the first and second actuators 24A and 24B with the cover 50, the wiring member 40 may include only the first wiring portion 40a along the outer shape of the first actuator 24A and may not include the second wiring portion 40b along the outer shape of the second actuator 24B. In this case, the cover 50 may include only the first cover main body portion 60A that covers the first actuator 24A, the second cover main body portion 60B that covers the second actuator 24B and the first wiring storage portion 62A, and may not include the second wiring storage portion 62B.

The cover 50 may not be divided into the plurality of divided bodies 80 and 82. For example, in a case where the actuator unit 10 includes only the first actuator 24A, the first actuator 24A may be covered with the cover 50 of a single member. The boundary portion between the two divided bodies 80 and 82 may be provided to divide the wiring storage portions 62A and 62B formed by the two divided bodies 80 and 82 in the length direction. In addition, the boundary portion between the two divided bodies 80 and 82 may be provided to divide a portion of the cover 50 other than the wiring storage portions 62A and 62B. The divided bodies 80 and 82 adjacent to each other may not be connected to each other by using the engagement unit 94.

In order to obtain the same effect as in (A) described above, it is sufficient that the first actuator 24A, the first wiring portion 40a of the wiring member 40, and the first cover portion 52 and the first wiring storage portion 62A of the cover 50 are present, and the second actuator 24B, the second wiring portion 40b of the wiring member 40, and the second cover portion 54 of the cover 50 are not essential. In addition, in order to obtain the same effect in a relationship with the first actuator 24A, the boundary portion between the two divided bodies 80 and 82 may be provided to divide the first wiring storage portion 62A of the first cover portion 52 of the cover 50 in the width direction. In a relationship with the first actuator 24A or the like, the effect of (A) described above may be understood by replacing the second actuator 24B, the second wiring portion 40b of the wiring member 40, the second cover portion 54 of the cover 50, and the second wiring storage portion 62B with the first actuator 24A, the first wiring portion 40a of the wiring member 40, the first cover portion 52 of the cover 50, and the first wiring storage portion 62A.

The embodiments and modifications described above are examples. The technical idea abstracted from these examples should not be construed as being limited to the contents of the embodiments. The contents of the embodiments can be subjected to many design changes such as changes, additions, and deletions of components. In the embodiments described above, the content for which such design changes can be made is emphasized by adding a notation “embodiment”. However, changes in design are allowed even when there is no notation in the contents. Hatching added to cross sections in the drawings does not limit a material of a hatched object.

The present disclosure relates to a cover used in an actuator unit such as a robot.

It should be understood that the invention is not limited to the above-described embodiment, but may be modified into various forms on the basis of the spirit of the disclosure. Additionally, the modifications are included in the scope of the disclosure.

What is claimed is:

1. A robot comprising:
a joint portion;
an actuator that drives the joint portion;
a wiring member that is disposed outside the actuator; and
a cover that covers at least the actuator,
wherein the cover includes a cover main body portion, and a wiring storage portion that bulges in a direction away from the actuator with respect to the cover main body portion, the wiring member being stored in the wiring storage portion,
the wiring storage portion includes an outer protruding portion formed on an outer surface of the cover and an inner groove portion formed on an inner surface of the cover and positioned inside the outer protruding portion, and
the outer protruding portion protrudes in a direction away from the actuator with respect to the outer surface of the cover where the wiring storage portion is continuous.

2. The robot according to claim 1,
wherein the cover includes a widthwise continuous portion that is continuous in a width direction with respect to the wiring storage portion, and
the widthwise continuous portion is provided along an outer shape of the actuator covered by the widthwise continuous portion.

3. The robot according to claim 1, further comprising:
a plurality of robot members connected in series by a plurality of the joint portions.

4. The robot according to claim 1,
wherein the cover is divided into at least a first divided body and a second divided body.

5. The robot according to claim 4,
wherein the wiring storage portion is formed by at least the first divided body and the second divided body.

6. The robot according to claim 5,
wherein a boundary portion between the first divided body and the second divided body is provided to divide the wiring storage portion in a width direction.

7. The robot according to claim 6,
wherein the first divided body and the second divided body are resin molded products molded by three-dimensional modeling.

8. The robot according to claim 4,
wherein the first divided body and the second divided body are connected to each other by an engagement portion provided in one of the first divided body and the second divided body being engaged with an engagement target portion provided in the other of the first divided body and the second divided body.

9. The robot according to claim 1,
wherein the joint portion includes a first joint portion and a second joint portion,
the actuator includes a first actuator that drives the first joint portion and a second actuator that drives the second joint portion, and
the cover covers both the first actuator and the second actuator.

10. The robot according to claim 9,
wherein the wiring member includes a first wiring portion that is disposed along an outer shape of the first actuator and a second wiring portion that is disposed along an outer shape of the second actuator, and
the wiring storage portion includes a first wiring storage portion that stores the first wiring portion and a second wiring storage portion that stores the second wiring portion.

11. The robot according to claim 9, further comprising:
a connection member that connects the first actuator and the second actuator,
wherein the cover covers the connection member.

12. The robot according to claim 1,
wherein the cover includes a restraining portion that restrains movement of an intermediate portion of the wiring member.

13. The robot according to claim 11,
wherein the cover includes a cover fixation portion for fixing the cover to the first actuator, the second actuator, or the connection member, and the cover fixation portion is provided in each of a first divided body and a second divided body of the cover.

14. A cover that is used in an actuator unit including an actuator and a wiring member disposed outside the actuator and that covers the actuator, the cover comprising:
a cover main body portion; and
a wiring storage portion that bulges in a direction away from the actuator with respect to the cover main body portion, the wiring member being stored in the wiring storage portion.
